(19) United States
(12) Patent Application Publication
(10) Pub. No.: US 2021/0386061 A1
(43) Pub. Date: Dec. 16, 2021

(54) Textured copper tape

(71) Applicant: Bradley C. Hollander, Minden, NV (US)

(72) Inventor: Bradley C. Hollander, Minden, NV (US)

(21) Appl. No.: 17/300,406

(22) Filed: Jun. 15, 2021

Related U.S. Application Data
(60) Provisional application No. 63/102,404, filed on Jun. 15, 2020.

(51) Int. Cl. A01N 25/34; A01N 59/20

(52) U.S. Cl. CPC A01N 25/34; B23P 9/00; A01N 59/20

(57) ABSTRACT

A method for the fabrication of a textured copper or brass substrate in order to improve its disinfection process. The substrate can be a textured copper or brass tape or any product or touch surface that can be texturized. The textured metallic substrate can be a tape or a sheet or film or panel or any metallic surface that can be texturized (e.g. door knobs, hand rails, medical equipment, or table tops). Thus, already existing touch surfaces can be treated with the inventive texturing to enhance its disinfection effectiveness and reduce the transmission of diseases. The texturization process may be determined by the microbes to be confronted and their determined dimensions and configurations and may be texturized to a depth and width of between 2-10,000 microinches.

### CROSS REFERENCE TO RELATED APPLICATIONS

This application claims the benefit of Provisional Application 63/102,404, filed Jun. 15, 2020, entitled “Improved Disinfection of Copper Surfaces and Retrofit of Touch Surfaces”, the disclosure of which is incorporated herein by reference.

### BACKGROUND OF THE INVENTION

### 1. Field of the Invention

The present invention relates to either forming a textured copper substrate or applying texturing any preexisting surface.

### 2. Description of the Related Art

The use of metallic copper as an antimicrobial surface dates back to between the 5th and 6th millennia B.C. It was the first metal used, presumably because it could be found in a native, metallic form which did not require smelting. Its use remained scattered throughout Europe and the Middle East. Authors Gregor Grass, Christopher Rensing, and Marc Solioz wrote in “Metallic Copper as an Antimicrobial Surface” that:

“Bacteria, yeasts, and viruses are rapidly killed on metallic copper surfaces, and the term “contact killing” has been coined for this process. While the phenomenon was already known in ancient times, it is currently receiving renewed attention. This is due to the potential use of copper as an antibacterial material in health care settings. Contact killing was observed to take place at a rate of at least 7 to 8 logs per hour, and no live microorganisms were generally recovered from copper surfaces after prolonged incubation. The antimicrobial activity of copper and copper alloys is now well established, and copper has recently been registered at the U.S. Environmental Protection Agency as the first solid antimicrobial material. In several clinical studies, copper has been evaluated for use on touch surfaces, such as door handles, bathroom fixtures, or bed rails, in attempts to curb nosocomial infections. In connection to these new applications of copper, it is important to understand the mechanism of contact killing since it may bear on central issues, such as the possibility of the emergence and spread of resistant organisms, cleaning procedures, and questions of material and object engineering. Recent work has shed light on mechanistic aspects of contact killing. A few general principles appear clear: higher copper content of alloys, higher temperature, and higher relative humidity increased the efficacy of contact killing. Treatments that lowered corrosion rates, e.g., application of corrosion inhibitors or a thick copper oxide layer, lowered the antimicrobial effectiveness of copper surfaces.”

### SUMMARY OF THE INVENTION

Heavy metals including gold and silver are antibacterial, but copper's specific atomic makeup gives it extra killing power. Copper has a free electron in its outer orbital shell of electrons that easily takes part in oxidation-reduction reactions. Silver and gold do not have the free electron, so they are less reactive. Thus, when a microbe lands on copper, ions blast the pathogen like an onslaught of missiles, preventing cell respiration and punching holes in the cell membrane or viral coating and creating free radicals that accelerate the kill, especially on dry surfaces. Most importantly, the ions seek and destroy the DNA and RNA inside a bacteria or virus or mold, preventing the mutations that create drug-resistant superbugs.

The invention provides a method for the fabrication of a textured copper tape. The textured copper tape is merely exemplary of the plethora of products that can utilize the invention. The textured metallic substrate can be the exemplary tape or a sheet or film or panel or any metallic surface that can be texturized (e.g. door knobs or hand rails). Thus, already existing touch surfaces can be treated with the inventive texturing to enhance its disinfection effectiveness.

The preferred metallic substrate copper or brass. Additives of zinc or other materials may be used but are generally less effective at reducing or disinfecting microorganisms, mold, spores, viruses etc.

The invention is achieved by realizing that the copper substrate must be texturized in order to activate the copper, thereby increasing the germicidal effect and shorten the time needed to kill microbes. During usage of the substrate (commonly called “touch surfaces”), the environmental conditions of its use (e.g. weathering, dirt, fingerprints or debris) tend to reduce the germicidal effect. The texturizing will compensate for the traditional environmental impacts. The method used to texturize the surface can be accomplished by any known process and the resultant shape, design, depth and other design elements of the texturization can be dictated by the eventual use of the substrate. The texture of the substrate allows the microbes to fall into the activated copper surfaces in order to enhance the disinfection process (increases the points of contact between the microbe and the copper) as opposed to a non-textured surface (that is, smooth or flat). Thus, already existing touch surfaces can be treated with the inventive texturing to enhance its disinfection effectiveness and prevent or at least reduce the transmission of disease.

The dimensions and configuration of the textured surface can match the microbes intended to be confronted. The surface roughness can be between 2-10,000 microinches (uin). The roughness will be dependent upon the specific application. For example, if the use is primarily for viruses, the texturization process and specific configuration of the textured surface will be different than if the use is for a certain bacteria or mold. Viruses are in the size range of 0.005-0.3 microns (um); bacteria 0.3-60 microns; mold 3-12 microns; mold spores 10-20 microns; and anthrax 1-5 microns. These microbes also possess different shapes (e.g. long, short, round, spiral, pointed, etc.). In effect, different microbes are killed by different surface configurations.

The invention further realizes that certain mold and spores are large and may settle on top of a textured surface that only uses one type of texturization (e.g. scratches or depressions). The invention realizes that either a different texture is needed (e.g. points or protuberances) or the points or protuberances may be added to the original texturing.

These and other features of the present invention will become readily apparent upon further review of the following specification and drawings.

### BRIEF DESCRIPTION OF THE DRAWINGS

FIG. 1 is a schematic drawing of a textured tape incorporating features of the invention.

FIG. 2 is a photo micrograph of the texture depicted in FIG. 1.

Similar reference characters denote corresponding features consistently throughout the attached drawings.

### DETAILED DESCRIPTION OF THE PREFERRED EMBODIMENTS

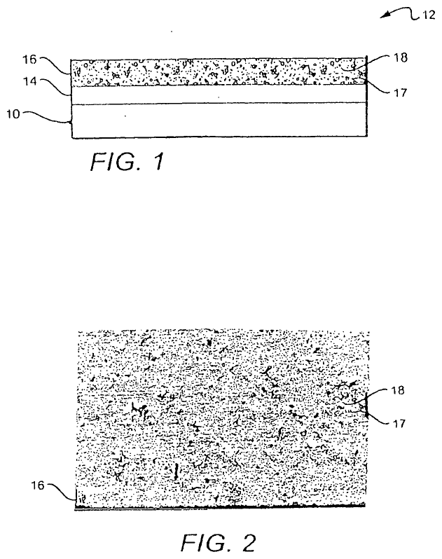

The invention provides a method for the fabrication of a textured copper tape 12, as shown in FIG. 1. The textured copper tape is merely exemplary of the plethora of products that can utilize the invention. The tape can have a release layer 10, followed by an adhesive layer 14. The textured metallic substrate can be the exemplary tape or a sheet or film or panel or any metallic surface that can be texturized (e.g. door knobs or hand rails). Thus, already existing touch surfaces can be treated with the inventive texturing to enhance its disinfection effectiveness and prevent or at least reduce the transmission of disease.

The preferred metallic substrate copper or brass. Additives of zinc or other materials may be used but are generally less effective at reducing or disinfecting microorganisms, mold, spores, viruses etc.

The invention is achieved by realizing that the copper substrate must be texturized (as depicted in FIG. 1, elements 16, 17, and 18) in order to activate the copper. The method used to texturize the surface can be accomplished by any known process and the resultant shape, design, depth and other design elements of the texturization can be dictated by the eventual use of the substrate. The texture of the substrate allows the microbes to fall into the activated copper surfaces in order to enhance the disinfection process (increases the points of contact between the microbe and the copper) as opposed to a non-textured surface (that is, smooth or flat).

The dimensions and configuration of the textured surface preferably matches microbes intended to be confronted. The texturization may take the configuration of a single pattern 16 or a plurality of different patterns 16, 17, and or 18, as depicted in FIGS. 1 and 2. The surface roughness can be between 2-10,000 microinches (uin). The roughness will be dependent upon the specific application. For example, if the use is primarily for viruses, the texturization process and specific configuration of the textured surface will be different than if the use is for a certain bacteria or mold. Viruses are in the size range of 0.005-0.3 microns (um); bacteria 0.3-60 microns; mold 3-12 microns; mold spores 10-20 microns; and anthrax 1-5 microns. These microbes also possess different shapes (e.g. long, short, round, spiral, pointed, etc.). In effect, different microbes are killed by different surface configurations.

As shown in FIGS. 1 and 2, the invention further realizes that certain mold and spores are large and may settle on top of a textured surface that only uses one type of texturization (e.g. scratches or depressions). The invention realizes that either a different texture is needed (e.g points or protuberances) or the points or protuberances may be added to the original texturing. FIGS. 1 and 2 generally depict the different types of textures 16, 17, and 18 that may be combined

It is to be understood that the present invention is not limited to the embodiments described above, but encompasses any and all embodiments within the scope of the following claims.

I claim:

1. A method of disinfecting a copper substrate, comprising the steps of:
analyzing the type of microbe or microbes to be disinfected;
determining the physical configuration and dimensions of the microbe or microbes;
providing a copper substrate;
determining the texture to incorporate onto the surface of the copper substrate based upon the physical configuration and dimensions of the microbe or microbes; and
texturizing the copper substrate with the determined texture.

2. The method of making a disinfecting copper substrate as recited in claim 1, wherein the depth and width of the texturing is between 5-500 microinches.

3. A method of disinfecting a copper substrate, comprising the steps of:
providing a copper substrate;
analyzing the environmental conditions of its use; and
s determining the texturization to be applied to the substrate based upon its environmental conditions.

4. A textured copper substrate comprising a copper substrate selected from the group consisting of a tape, sheet or panel, wherein the surface of the copper substrate is texturized to a depth and width of between 2-10,000 microinches.

5. The textured copper substrate as recited in claim 4, wherein the depth and width is between 5-125 microinches.

6. The textured copper substrate as recited in claim 3, wherein the depth and width is between 125-500 microinches.
